(19) United States
(12) Patent Application Publication
(10) Pub. No.: US 2026/0336912 A1
(43) Pub. Date: Oct. 29, 2026

(54) CAPSULE DISPENSER, SYSTEM AND BEVERAGE-MAKING MACHINE

(71) Applicant: Delica AG, Buchs (CH)

(72) Inventors: Xianming FU, Shenzhen City (CN); Lu HUANG, Shenzhen City (CN); Michael THURNHERR, Rapperswil (CH); Roland AFFOLTER, Möriken (CH); Ralf VAN DEN BRAGT, Sankt Pantaleon (CH)

(73) Assignee: Delica AG, Buchs (CH)

(21) Appl. No.: 19/104,007

(22) PCT Filed: Aug. 18, 2023
(86) PCT No.: PCT/EP2023/072769

§ 371 Date: Feb. 14, 2025

(30) Foreign Application Priority Data
Aug. 18, 2022 (CH) CH000973/2022

(51) Int. Cl. B65D 83/04; A47J 31/36

(52) U.S. Cl. CPC B65D 83/04; A47J 31/3642; B65D 2583/049

(57) ABSTRACT

A capsule dispenser for receiving and dispensing substantially rotationally symmetrical capsules in an operating position, comprising a receiving element and a moving element. The receiving element defines a receiving area for the capsules. The capsule dispenser has a dispensing area for dispensing a capsule. By a relative movement between the receiving element and the moving element, a capsule can be moved into the dispensing area and can be discharged from the dispensing area. At least the movement of the capsule into the dispensing area or the movement for discharging the capsule from the dispensing area comprises a rotation of the capsule about one of its axes of symmetry.

The invention relates to a capsule dispenser, a system comprising a capsule dispenser, and a beverage preparation machine comprising a capsule dispenser.

Preparing drinks with capsules offers consumers a number of advantages. A capsule filled with a beverage substance can provide a user with a quick and also low-preparation and low-cleaning option for preparing beverages. In addition, the preparation of beverages with capsules is possible without prior knowledge and with constant quality and quantity of the beverage for a consumer.

In this context, the term beverages includes in particular coffee, tea, milk, hot or cold chocolate drinks, soups and/or liquid foods.

Various devices for feeding capsules to a beverage preparation machine are known in the prior art, for example WO 2019/219523 Al shows a beverage portion dispenser with a portioning belt for holding beverage precursor portions. However, the design is complicated, requires predefined orientations of the capsules and only works by actively translating the capsules through the portioning belt.

EP 2 617 333 A1 discloses a capsule feeding device for the production of brewed beverages. However, the capsule feeding device is also based on a complicated structure, predefined orientations of the capsules, and a design of the capsules by means of translational movements.

The feeding of capsules in the state of the art is often complicated and prone to malfunctions. In addition, there is often a lack of a simple, intuitive and quick method for feeding capsules into a beverage preparation machine. A high level of force is also often required to extract the capsules.

In addition, the filling and/or successive dispensing of a large number of capsules, especially rotationally symmetrical capsules, from a capsule dispenser is often complicated and not user-friendly. In particular, the capsules often have to be aligned in order to assume a certain spatial orientation in the capsule dispenser.

It is a task of the present invention to overcome these and other disadvantages of the prior art. In particular, the aim is to enable simple and cost-effective dispensing of capsules.

This task is solved by the devices defined in the independent claims. Further embodiments result from the dependent claims.

A capsule dispenser according to the invention for receiving and dispensing substantially rotationally symmetrical capsules in an operating position comprises a receiving element and a moving element. The receiving element defines a receiving area for the capsules. The capsule dispenser also has a dispensing area for dispensing a capsule. A capsule can be moved from the receiving area into the dispensing area and the capsule can be discharged from the dispensing area by means of relative movement between the receiving element and the moving element. At least the movement of the capsule into the dispensing area or the movement of the capsule for removal from the dispensing area comprises a rotation of the capsule about one of its axes of symmetry.

The operating position of the capsule dispenser is defined by its position during intended use. Preferably, the capsule dispenser is arranged on a substantially horizontal surface, in particular a connection area of a beverage preparation machine.

The term capsule includes capsules with an at least partially rotationally symmetrical geometric shape, in particular a cone, a cylinder, an ellipsoid and above all a sphere.

The term capsule also includes any form of pre-portioned beverage ingredients or beverage components. The capsule may further comprise an oxygen-tight and aroma-tight wrapper that encloses beverage ingredients and beverage components prior to use, in particular protective layers and/or packaging made of plastic, organic polymers, in particular polyolefin or polyethylene, bio-degradable organic polymers, and/or metals such as aluminum.

An essentially rotationally symmetrical and rotatable capsule offers the advantage of an optimized filling volume with a minimal surface area, especially for spherical capsules. The dispensing of the capsule is simplified through a rolling movement.

The capsule is essentially rotationally symmetrical along at least one axis, preferably two different axes. A completely rotationally symmetrical capsule is advantageous, as the capsule does not have to be spatially aligned in the capsule dispenser. Thus, the complexity and size of the capsule dispenser can be optimized.

The term receiving area is defined by an area for receiving the capsules, such as an enclosed chamber, a tray, or a rail system.

The receiving element and/or the moving element can comprise at least one contact element, preferably a partition wall, which contacts at least one capsule when the relative movement is performed. This contact element can move the at least one capsule into the dispensing area or out of the dispensing area as a result of the relative movement and the rotational movement about at least one of the axes of symmetry of the capsule.

The receiving element or the moving element may be shaped such that at least one capsule is retained by the shape of the receiving element or the moving element when the capsule is in the receiving area or optionally in the dispensing area.

The dispensing area can comprise an opening mechanism that has a closed state for retaining a capsule in the dispensing area and an open state for discharging a capsule from the dispensing area. This offers the advantage that the desired capsule can be selected by repeated relative movement and a capsule can only be dispensed from the dispensing area when the opening mechanism is actuated.

Preferably, the relative movement does not counteract the gravity acting on the capsules. The force for the relative movement can therefore be further reduced.

When the capsule is in the dispensing area, the capsule can preferably be dispensed by gravitational action alone, without the need for further relative movement or actuation.

Preferably, exactly one capsule can be dispensed by the relative movement over a predetermined distance. Thus, the capsules can be sequentially discharged one after another through repeated relative movements, each over the specifically predetermined distance, through the dispensing area.

The receiving area can be inclined to the horizontal at least in part or completely in the operating position of the capsule dispenser.

The receiving area can have a base surface which, in the operating position, is inclined to the horizontal at right angles to the direction of relative movement, at least in a partial area of the receiving element. This has the advantage that the capsules are arranged in an area of the receiving area by gravity alone.

In the operating position, the receiving area can be inclined, optionally completely, in the direction of the dispensing area. This allows the force required for relative movement to be further reduced.

The receiving element may be shaped such that, in the operating position, it can receive a plurality of capsules in a plane that is inclined to the horizontal. Such an inclination is advantageous, as capsules are thus automatically fed to the dispensing area if they are not retained. At least one capsule may be retained by a retaining element, optionally the moving element or receiving element. This is advantageous because capsules can thus be automatically fed to the dispensing area by gravity, preferably in a predefined order, when a retaining element is removed.

The receiving element may be shaped such that, in the operating position, it can hold a plurality of capsules in a substantially horizontal plane. Such an arrangement enables a compact shape of the capsule dispenser and stable storage of the capsules in the receiving area.

The dispensing area may be at least partially inclined, preferably inclined transversely to the direction of relative movement in the operating position. The inclination of the dispensing area may preferably be sufficient to allow a capsule to be carried out of the dispensing area by gravity alone. Such a dispensing area offers the advantage that no additional dispensing mechanism is required and thus the capsule dispenser can be manufactured more easily and cost-effectively.

The inclination of the receiving area and/or the dispensing area in the operating position can be at least 1.5°, in particular at least 3°, especially preferably at least 10°, relative to the horizontal. Small angles of inclination are advantageous in terms of manufacturing technology and are nevertheless suitable for at least partially rotationally symmetrical capsules.

The dispensing area can be inclined more or less than the receiving area. The inclination can be used to optimize the discharge of the capsules by gravity.

The receiving area can have a continuous base area or a large number of interconnected sub-areas. Additional material can be saved by having many connected sub-areas, so that a grid or a receiving area with recesses is formed. The sub-areas can also prevent unwanted movement of the capsules by holding the capsules between two sub-areas in the receiving area, for example.

The receiving area for receiving the capsules can be designed to complement the shape of a capsule, in particular a plurality of capsules. The complementary design can extend in the direction of relative movement. Such a complementary configuration, for example a groove, can predetermine the rotation of the capsules about one of their axes of symmetry in one direction. Thus, the force required for the relative movement can be additionally reduced, as the loss of force due to undirected movements and/or friction of the capsules is minimized.

The capsules can preferably be arranged in order in the receiving area so that the capsules can be carried out of the dispensing area in a predetermined sequence by successive relative movements.

The receiving area may have a discharge device configured to discharge the capsule by the relative movement between the receiving element and the moving element at the dispensing area. The discharge device may be configured so that the capsule can be lifted at least partially against gravity by the discharge device and the relative movement.

This discharge device enables the capsules to be reliably dispensed from the dispensing area, in particular by the discharge device only interacting with the capsules in the dispensing area.

The discharge device can comprise at least one projection. The projection can protrude at least partially vertically from the base surface of the receiving element in the dispensing area in order to lift the capsules against gravity during relative movement. This enables the capsule to be moved to the dispensing area and to be lifted from a resting position only in the dispensing area in order to be dispensed.

The moving element and the receiving element can be connected or connectable to each other. Preferably, all capsules can be moved simultaneously by the relative movement. All capsules can be movable by the relative movement relative to the dispensing area. Such an arrangement has the advantage that by moving one capsule through a relative movement, further capsules can already be guided closer to the dispensing area. By successive relative movements, several capsules can thus be fed to the dispensing area one after the other.

The moving element can perform the relative movement to the receiving element. The receiving element can be arranged immovably. An immovable arrangement of the receiving element has the advantage that the capsule dispenser can be stably placed and, in particular, can be stably arranged on a beverage preparation machine.

The capsules can be moved relative to the dispensing area by the relative movement without the capsules rotating about one of their axes of symmetry, except in the dispensing area. The moving element can have at least one capsule holder for holding at least one capsule. The capsule holder can be configured so that the capsule merely touches the capsule holder.

This allows the capsules to be moved in a resting position that allows for a more frictionless movement of the capsules without the capsules rotating. This minimizes the torque acting on the capsules and ensures a smoother, seamless movement of the moving element relative to the receiving element.

The discharge device at the dispensing area and the capsule holder of the moving element may be configured so that the relative movement lifts the capsule out of the capsule holder and out of the dispensing area by rotating the capsule when the capsule holder is moved to the dispensing area.

The relative movement can be a rotational movement, so that one capsule after the other can be carried out of the dispensing area. A rotational movement has the advantage that the capsule dispenser can be placed in one position without the need for translational movements to carry out the capsules. In addition, the capsule dispenser in an original orientation can preferably be transferred back to the original orientation by a large number of rotational movements in the same direction. The rotational movement also enables space-saving and optimized dimensioning of the capsule dispenser.

The rotational movement is preferably a rotational movement in a constant direction of rotation. A constant direction of rotation is advantageous because it makes it easier for a user to use.

The rotational movement can optionally feed capsules to the dispensing area in two rotational directions. This offers the advantage that a user can use different types of capsules in one capsule dispenser. A rotational movement in a first direction can be used to feed a first type of capsule to the dispensing area and a rotational movement in another direction can be used to feed a second type of capsule to the dispensing area.

The dispensing area may include a passageway for discharging the capsule from the capsule dispenser.

An axis of rotation of the rotational movement can essentially run through a central area, in particular through the center of gravity, of the capsule dispenser. The axis of rotation can run through the center area of the moving element and/or receiving element. Such an axis of rotation offers the advantage that the capsule dispenser can be designed to be space and material efficient.

The axis of rotation can run vertically through the capsule dispenser in the operating position. A vertical axis of rotation enables easy operation and arrangement of the capsule dispenser.

However, the axis of rotation can also run horizontally or at any angle through the capsule dispenser in the operating position.

The capsule dispenser may comprise sections, preferably sections of angular regions, in particular preferably sections of angular regions in a horizontal plane in the operating position. Each section can be delimited by two separating elements, in particular partition walls, forming an area, preferably an at least partially prism-shaped area, for receiving exactly one capsule.

The sections can simplify the portioning of the capsules and define a clearly recognizable order of the capsules.

The sections can be formed by the moving element, the receiving element or both.

The receiving element and/or the moving element can engage after the relative movement over the predetermined distance, preferably along exactly one angular region of a section. By engaging, an at least slightly increased resistance for a new relative movement can be generated. This engagement gives a user haptic feedback when the relative movement has reached the predetermined distance for dispensing exactly one capsule.

The support element and/or the moving element can have recesses and/or projections for engaging. The recesses and projections of the support element and moving element can be designed to complement each other.

All angular regions of the sections can have a uniform size. A uniform size offers the advantage that the capsules, which normally have a uniform size, can be picked up evenly in the angular regions.

The capsule dispenser can comprise a side wall element that is essentially vertical in the operating position. This allows the capsules to be positioned particularly stably in the receiving area and also protects them from interference and soiling.

Optionally, the side wall element is connected or can be connected to the receiving element. Such a side wall element enables a compact design.

The side wall element can comprise a partial area of the dispensing area, in particular the passageway of the dispensing area. Such a side wall element is advantageous, as the capsules can thus be discharged from the capsule dispenser transversely to the direction of relative movement through the side wall element. In addition, the passageway arranged transversely to the relative movement protects the capsule dispenser from moisture penetrating from a beverage preparation machine that can be arranged below the capsule dispenser.

The receiving element can include the passageway of the dispensing area. A passageway in the receiving element enables a compact capsule dispenser and simpler capsule design.

The passage can be adapted to the three-dimensional shape of the capsule. The capsule can only be fed through the passage in a certain orientation of its three-dimensional shape. This offers the advantage that the capsules can only be carried out in the correct orientation and can otherwise be retained.

In the operating position, the dispensing area can essentially comprise a horizontal passageway or a vertical passageway.

A horizontal passageway can be arranged in the center of the capsule dispenser in an operating position. Such an arrangement offers the advantage that the capsules can be easily and reliably removed from the dispensing area.

The side wall element can form a continuous wall, in particular a continuous wall that is closed in the circumferential direction, apart from an optional passageway.

The side wall element can block movement of the capsules transverse to a direction of movement to the dispensing area. In this way, the receiving area can be limited and the capsules can be stored stably.

The capsule dispenser can comprise a lid that is connected or can be connected to the moving element or the receiving element, so that a relative movement of the lid causes a relative movement of the moving element or receiving element.

The lid can therefore make the capsule dispenser easy to use and at the same time protect it from dust.

The lid of the capsule dispenser can be removable in order to fill the capsule dispenser in the operating position from above with at least one, preferably a plurality of capsules. Such a lid makes it easier to fill the capsule dispenser.

The lid can include the separating elements of the sections. This means that the separating elements can be removed together with the lid so that the receiving area can be filled without separating elements. After filling, the lid can be reattached so that the capsules are divided into the sections by the separating elements.

The receiving area can be designed to arrange the capsules at a substantially equal distance from each other, in particular in an area of the receiving element laterally transverse to the direction of relative movement. This offers the advantage that the capsules can be separated from each other more easily and the capsules can be carried out more easily one after the other.

The receiving element, in particular the base surface of the receiving element or a base surface of the moving element, can have an at least partially or completely polygonal, oval or round shape. The base surface can be circular.

The capsule dispenser can at least partially have the three-dimensional shape of a circular cylinder, an elliptical cylinder, or a prism, in particular a regular prism. Such a three-dimensional shape has the advantage that the capsule dispenser can be manufactured compactly and cost-effectively.

The capsule dispenser can comprise an operating element, preferably with an operating mechanism, for causing the relative movement.

Such an operating element can facilitate and/or indicate the operation of the capsule dispenser to a user.

The operating element can be a manual operating element for manual operation by a user. The manual operating element can have a manual operating mechanism, in particular with a handle, a lever or a rubberized surface.

The manual operating element can be directly materially connected or at least connectable to the moving element and/or the receiving element. Actuation of the operating element can thus directly cause the relative movement.

Alternatively, the manual operating mechanism can include a transmission ratio. The transmission ratio means that actuation of the operating element can cause a smaller or larger relative movement.

The operating element can be of a mechanical nature. The mechanical operating element is therefore in particular a button, a switch or a sensor, in particular a capacitive sensor.

At least part of the capsule dispenser, preferably the complete capsule dispenser, can be transparent or semi-transparent.

A transparent or semi-transparent capsule dispenser or part of the capsule dispenser allows the user to quickly view the filling status of the capsule dispenser with capsules. In addition, a user can thus identify the type of beverage that can be prepared with the capsule by the shape, color or marking of the capsule.

The receiving element can have at least one connecting element for rotation-proof connection to a moving element of another, second capsule dispenser and/or to a connection area of a beverage preparation machine.

The term rotation-proof means that no rotation of the connected element relative to the receiving element is possible when the capsule dispenser is used properly.

The connecting element can be arranged on an underside of the receiving element in the operating position. This makes it particularly easy to attach the capsule dispenser. A connection of the connecting element that is additionally reinforced or supported by a gravitational force in the operating position is particularly advantageous.

The moving element and/or the connection area of a beverage preparation machine may have a complementary connecting element for receiving the connecting element of the receiving element.

The complementary connecting element can be arranged in the operating position on the upper side of the moving element and/or the connection area.

The connecting element can comprise protruding and/or lowered locking elements, in particular latching elements. It can also be laterally protruding and/or recessed locking elements.

The complementary connecting element of the moving element can be formed by a ribbed handle. If no connection is formed by the ribbed handle, the ribbed handle can serve as an operating element. Thus, the ribbed handle of the moving element can serve both as a connecting element and as an operating element.

The latches of the connecting element and the latches of the complementary connecting element can interlock, preferably positively.

The connecting element, the complementary connecting element and/or further connecting elements may comprise a partially or completely conical, cylindrical, prism-shaped or oval cylindrical lowered or protruding region.

A further aspect of the invention relates to a system comprising a capsule dispenser described above, and a plurality of capsules, wherein the capsules are arranged in the receiving area of the capsule dispenser. Preferably, the capsules are substantially rotationally symmetrical about at least one, preferably two different, axes. This allows a user to quickly and easily replace an empty capsule dispenser and/or avoid refilling individual capsules. For example, capsule dispensers that have already been filled can be marketed.

In the operating position, such a system can preferably be mounted in or the connection area of a beverage preparation machine ready for operation. This offers the advantage that the capsules can preferably be fed directly from the capsule dispenser to the beverage preparation machine and the operational effort is minimized.

A further aspect of the present invention relates to a system comprising at least two capsule dispensers as described above. In the operating position, the system comprises at least two, optionally three, four, five, or more, capsule dispensers arranged vertically one above the other, which are detachably connected to each other, preferably with at least one connecting element. Such a modular system offers the advantage that several capsule dispensers can be operated in parallel. This allows the capacity of the capsule quantity to be increased. In addition, several different types of beverages can be made available to a user in the capsule dispensers at the same time.

A movement of the side wall element and/or receiving element of the upper capsule dispenser in the operating position can be coupled to a relative movement of the lower moving element by the connecting elements.

A rotation of the upper side wall element and/or upper receiving element of the upper capsule dispenser can thus cause a rotational movement of the lower moving element. The upper capsule dispenser can thus be moved by the movement of the lower moving element.

Rotation of the upper moving element, on the other hand, is preferably not coupled to underlying components of the system by the connecting elements. This means that the upper moving element can be moved separately.

A further aspect of the present invention relates to a beverage preparation machine comprising at least one of the capsule dispensers described above. The beverage preparation machine has a connection area, in particular a recess, for connecting the capsule dispenser, in particular for receiving at least a part of a receiving element of the capsule dispenser.

The connection area can be designed in such a way that the receiving element of a capsule dispenser can be connected in a rotation-proof manner.

The receiving element and/or the connection area can be rotation-proof by means of a corresponding locking mechanism. The corresponding locking mechanism can comprise at least one protruding pin or a recess which blocks rotation in the circumferential direction of the capsule dispenser.

Alternatively or additionally, the receiving element can be lowered into a recess in the connection area in a form-fit, in particular rotation-proof and/or non-slip.

The receiving element can be detachably connectable to the connection area via a magnetic connecting element and, in particular, can be connected in a rotation-proof and/or non-slip manner. The capsule dispenser can also comprise a recess and/or a magnetic connecting element.

In the operating position, the receiving element can be attached to the beverage preparation machine in or to the connection area in a substantially vertical direction.

The beverage preparation machine may have an input area for inputting a capsule for beverage preparation.

The dispensing area of the capsule dispenser can correspond to the input area of the beverage preparation machine. The dispensing area can correspond to the input area in such a way that a capsule dispensed through the dispensing area is picked up directly by the input area of the beverage preparation machine without user interaction.

The term “corresponding” thus refers to the relative alignment and/or spacing of the dispensing area of the capsule dispenser to the input area of the beverage preparation machine.

The dispensing areas of several capsule dispensers can be arranged one above the other or can be arranged side by side.

The beverage preparation machine or capsule dispenser can comprise a guide device. The guide device can be arranged or can be arranged between the dispensing area and the input area. In particular, the guide device can be at least partially inclined to a horizontal plane in an operating position of the beverage preparation machine, so that a capsule discharged from the dispensing area can be fed to the input area merely by its own weight.

The operating position of the beverage preparation machine is defined by mounting the beverage preparation machine on an essentially horizontal surface so that capsules from a capsule dispenser can be fed to the input area in an operationally correct manner, preferably using only the capsules' own weight.

The guide device may comprise a guide track or a guide structure.

The guide device can be at least partially funnel-shaped, optionally completely funnel-shaped.

A brewing unit, in particular comprising a brewing chamber, can be arranged below the input area of the beverage preparation machine. The capsules can thus advantageously be fed directly from the capsule dispenser to the brewing unit of the beverage preparation machine.

The input area of the beverage preparation machine may have an access for capsules that is not blocked by the capsule dispenser in the operating position.

Thus, a user can alternatively or additionally manually feed capsules to the input area, although at least one capsule dispenser is located in or at the connection area.

A horizontal passage of the dispensing area in the operating position of the capsule dispenser can also be arranged in the receiving area vertically above the input area of the beverage preparation machine. This allows the capsules to be reliably fed from the dispensing area into the input area of the beverage preparation machine and also enables a space-saving arrangement.

The invention will now be described with reference to certain embodiments and figures showing the following:

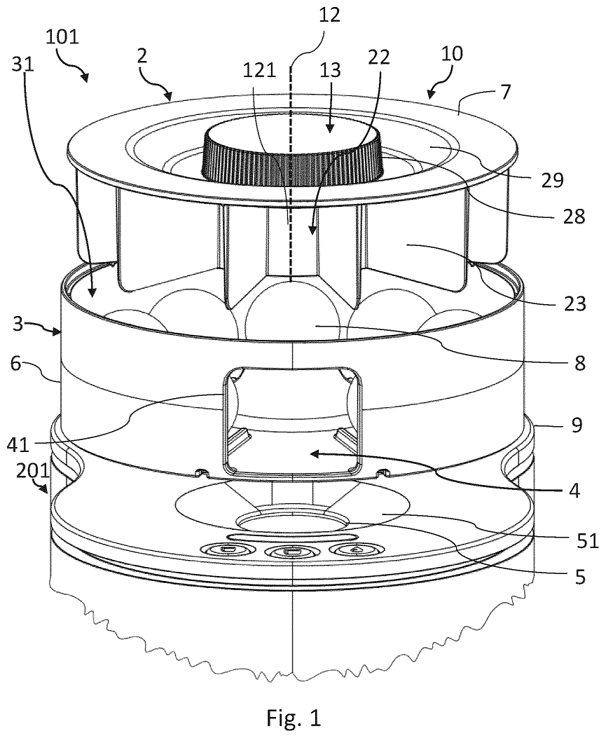

FIG. 1: an exploded perspective view of a capsule dispenser with capsules on a coffee machine,

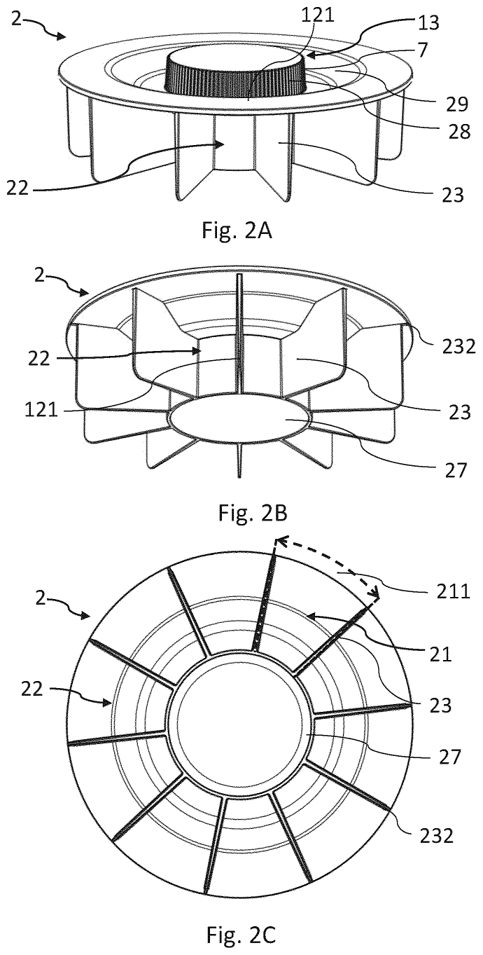

FIGS. 2A to 2C: a perspective view from above, an oblique side view from below, and a top view from below of the moving element,

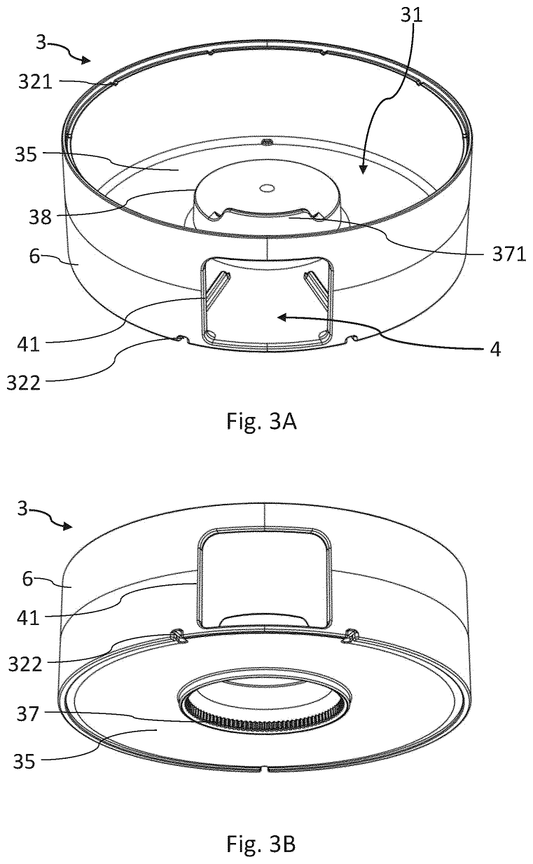

FIGS. 3A and 3B: a perspective view from above and an oblique side view from below of the receiving element,

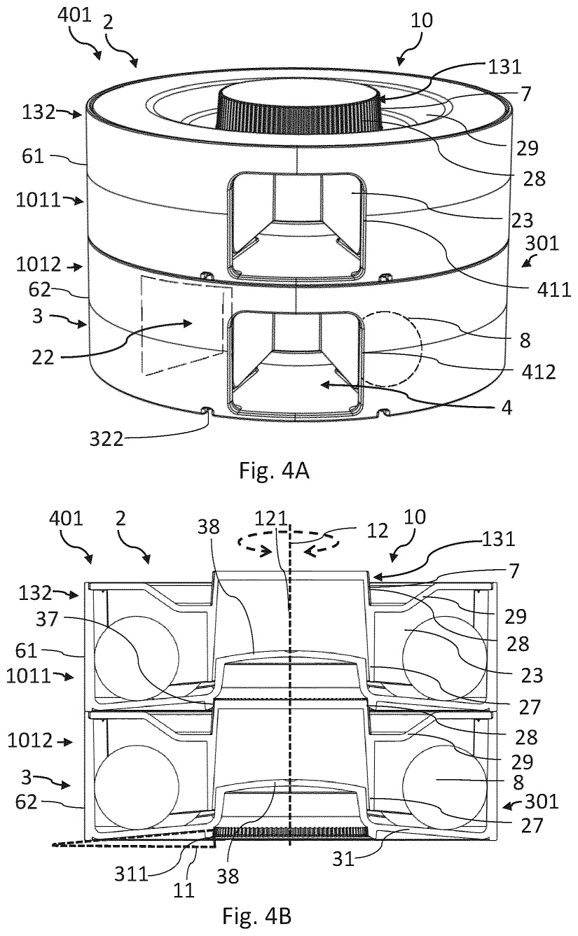

FIGS. 4A and 4B: a perspective view of a system comprising two capsule dispensers arranged one above the other and a cross-sectional view of the system,

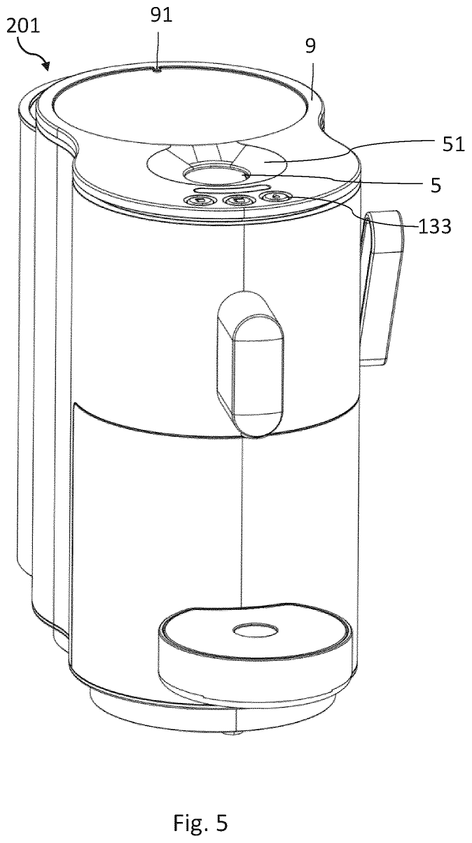

FIG. 5: a perspective view of a coffee machine with a connection area without capsule dispenser,

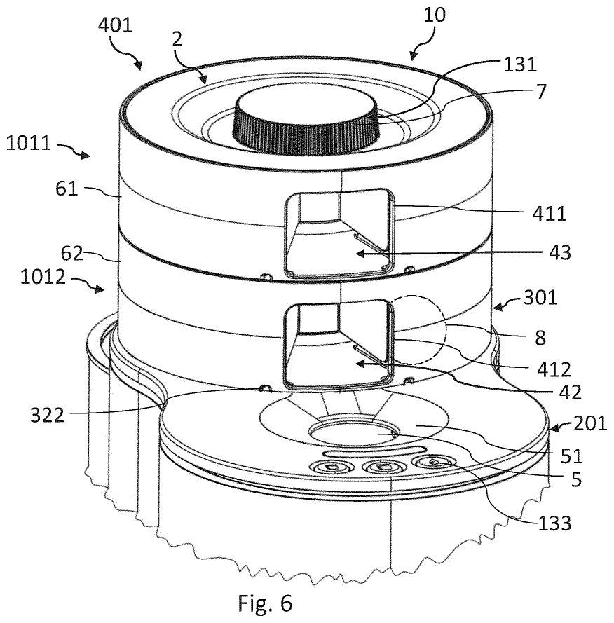

FIG. 6: a perspective view of a system comprising two capsule dispensers arranged one above the other on the coffee machine

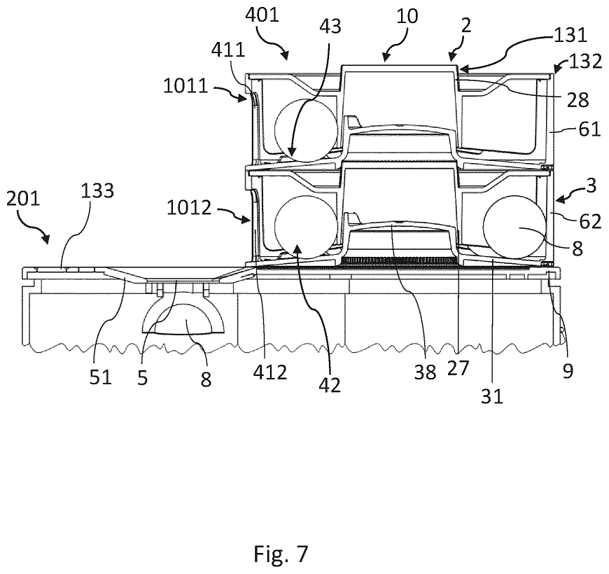

FIG. 7: a cross-section of the system and the coffee machine with capsules in the dispensing areas,

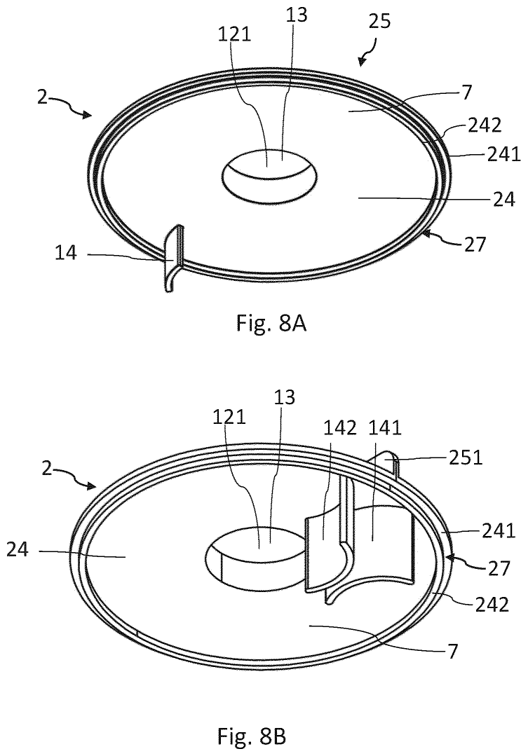

FIGS. 8A and 8B: a perspective view of a first and second alternative embodiment of the moving element,

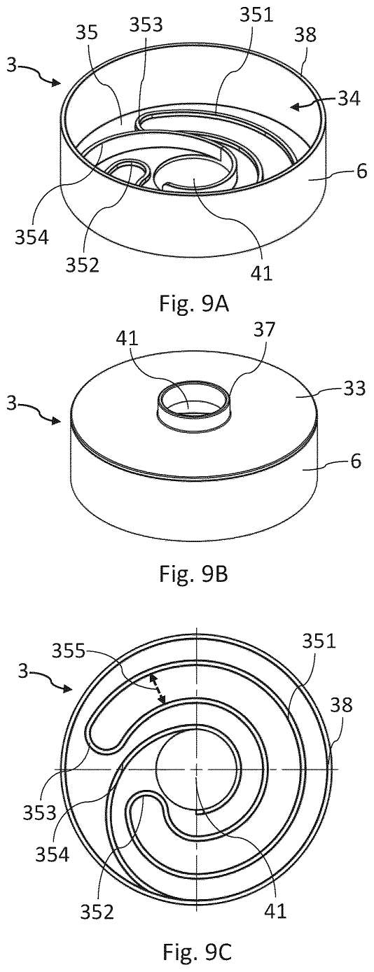

FIGS. 9A to 9C: a perspective view from above, an oblique side view from below, and a top view from above of a first alternative embodiment of the receiving element,

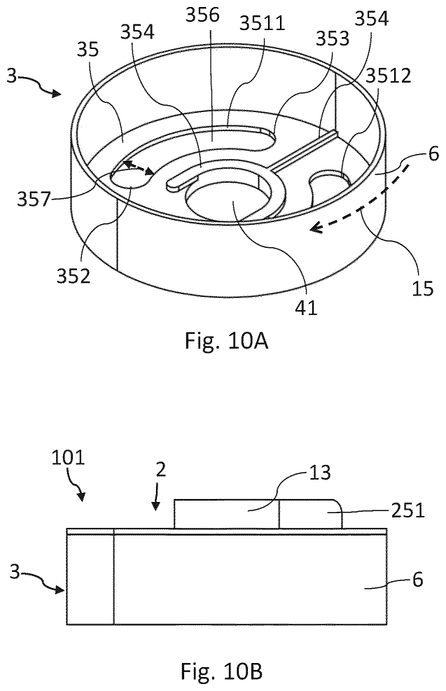

FIGS. 10A and 10B: a perspective view from above of a second alternative embodiment of the receiving element and a side view of a capsule dispenser comprising the receiving element according to FIG. 10A and a moving element according to FIG. 8B,

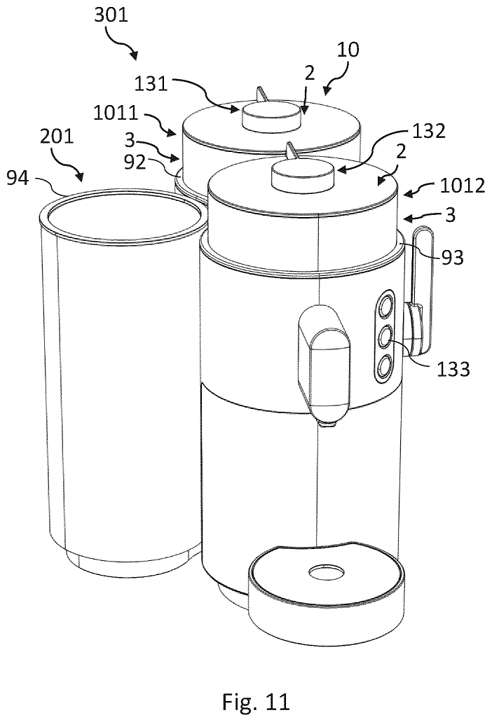

FIG. 11: a perspective view of a system comprising two capsule dispensers arranged next to each other on a coffee machine,

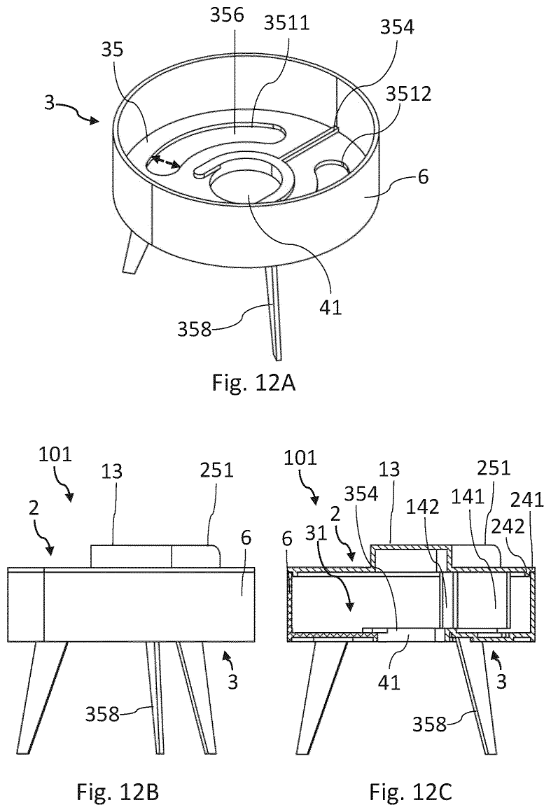

FIGS. 12A to 12C: a perspective view of the receiving element according to FIG. 9C with supporting legs, a side view and a side view in cross-section of the capsule dispenser comprising a receiving element according to FIG. 12A and a moving element according to FIG. 8B,

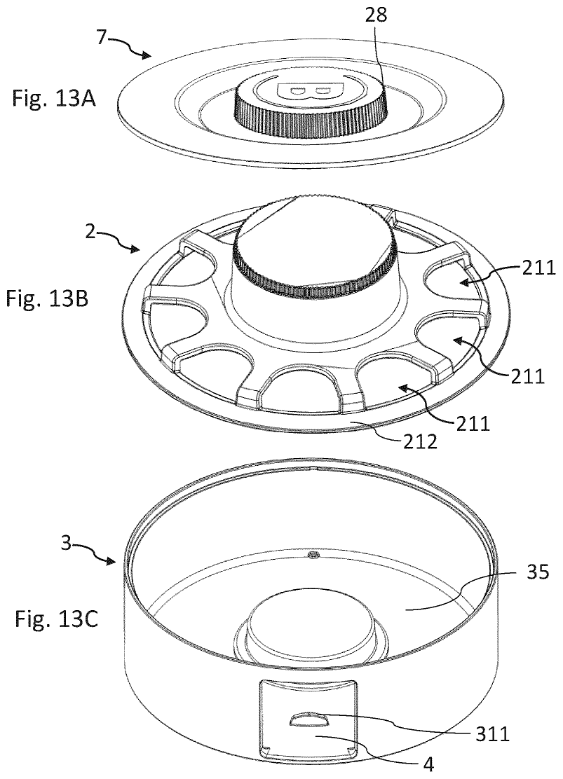

FIGS. 13A-13C : a perspective view of a lid, a moving element and a receiving element of an embodiment of the capsule dispenser,

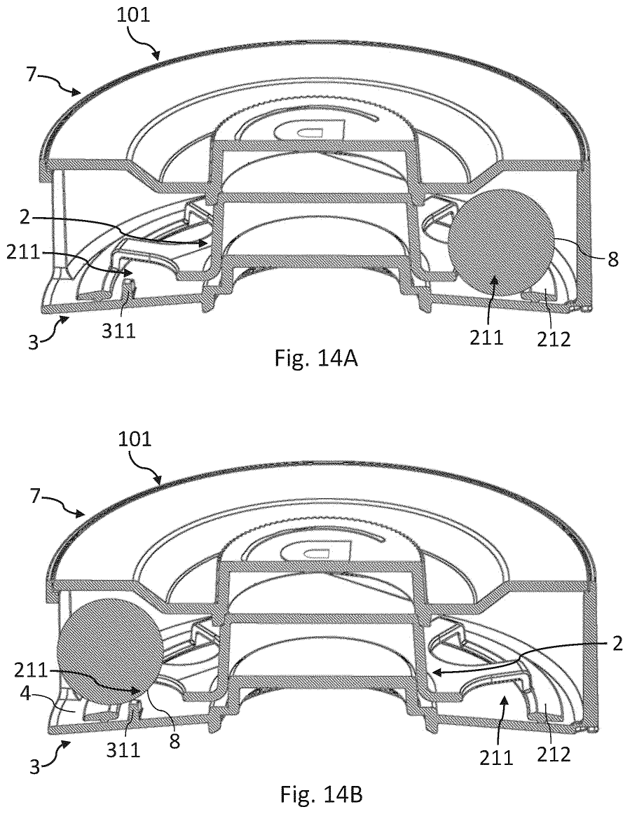

FIGS. 14A and 14B: a cross-sectional view of a capsule dispenser according to FIGS. 13A-13C with a spherical capsule held by the moving element and discharged from a dispensing area by a projection of the receiving element.

FIG. 1 shows an exploded view of a capsule dispenser 101 filled with capsules 8, which is mounted on a coffee machine 201. In an operating position 10, the capsule dispenser 101 is mounted on the coffee machine 201 in a connection area 9 of the coffee machine 201. In the operating position 10, the capsule dispenser 101 is oriented such that all capsules 8 are in a horizontal plane. The upper part of the capsule dispenser 101 is formed by a moving element 2 and a lower part of the capsule dispenser 101 is formed by a bowl-shaped receiving element 3. The moving element 2 is shown in a raised position. The moving element 2 can be connected to the receiving element 3 in the operating position 10, so that the moving element 2 can be rotated relative to the receiving element 3 in two directions of rotation. The receiving element 3 encloses a receiving area 31 in the circumferential direction with a side wall element 6, so that the capsules 8 can be mounted in the receiving area 31. The side wall element 6 is aligned essentially vertically in the operating position.

The moving element 2 of the capsule dispenser 101 is materially connected to a lid 7, which has a ribbed handle 28 that also serves as a connecting element. The moving element 2 is lowered vertically around the handle 28 in a substantially torus-shaped area 29. The moving element 2 also has a plurality of sections, each of which has two partition walls 23 enclosing prism-shaped areas 22 for receiving capsules 8 together with the side wall element 6. In the operating position 10, the capsules 8 are arranged substantially in a horizontal plane in the radially outer region of the capsule dispenser 101. The prism-shaped regions 22 are shaped to receive exactly one capsule 8.

The side wall element 6 has a passage 41 that is large enough to feed out a capsule 8, which is located in a dispensing area 4. The dispensing area 4 of the capsule dispenser 101 is arranged such that dispensed capsules 8 can be fed directly via a funnel 51 to an input area 5 of the coffee machine 201. In addition, the dispensing area 4 has an inclination towards the input area 5 of the coffee machine 201, so that capsules 8 can be carried out of the dispensing area 4 by gravity alone.

By rotating the ribbed handle 28 for a user, the moving element 2 can be rotated relative to the receiving element 3 which is rigidly fixed on the coffee machine 201. The ribbed handle 28 can thus be used as an operating element 13 for performing the relative movement by a user. By rotating the moving element 2, all capsules 8 of the capsule dispenser 101 can be rolled in the circumferential direction of the capsule dispenser 101. A relative movement corresponds to the rotation of the moving element 2 in the circumferential direction by the distance of the length of a section relative to the receiving element 3. The axis of rotation 12 extends vertically through the center of gravity 121 of the moving element 2. Each relative movement can thus feed a single capsule 8 to the dispensing area 4 by rolling the capsule to the dispensing area. The capsules 8 in this embodiment are spherical in shape, so that the capsules 8 are completely rotationally symmetrical. However, essentially prism-shaped, cylindrical or torus-shaped capsules 8 could also be imagined, which can be rolled to the dispensing area 4 by relative movements.

FIGS. 2A to 2C show an oblique side view from above, an oblique side view from below, and a top view from below of the moving element 2. The ribbed handle 28 of the lid 7 in FIG. 2A can be used as an operating element 13 and also as a connecting element for detachably connecting a receiving element 3 arranged above it (see FIGS. 4A and 4B). The corrugations of the handle 28 serve as a corresponding interlock with a connecting element of the receiving element 3. When a receiving element 3 is connected to the moving element 2 via the handle 28, the moving element 2 and the receiving element 3 can thus only be rotated together. The lid 7 of the moving element 2 has a recess 29 running in the circumferential direction in a central radial area. Thus, an upper side of the moving element 2 forms a bowl-shaped form with an elevation in the center, which forms the ribbed handle 28. The ribbed handle 28 is only slightly raised vertically in relation to the edge area of the moving element 2, so that the moving element 2 can be stacked easily (see FIG. 1) and a compact design of the capsule dispenser 101 is made possible. In addition, the elevation can ensure the connection with a receiving element 3 arranged above it. In addition, the capsule dispenser 101 can thus be only slightly higher than the spherical capsules 8 in order to save material. The partition walls 23 of the sections of the moving element 2 extend radially outwards in a straight line in a vertical plane passing through the center of gravity 121 of the moving element 2. In each case, two partition walls 23 enclose an area 22 of a section.

FIG. 2B shows a connecting element 27, which is attached to the underside of the moving element 2. This hollow cylindrical connecting element 27 can be detachably connected to the upper side of a receiving element, so that the moving element 2 can be rotated relative to the receiving element (see FIGS. 4A and 4B). The connecting element 27 is arranged in a central area of the moving element 2, so that the individual sections with the respective areas 22 are arranged in a horizontal plane around the connecting element 27. As can be seen in FIG. 2C, the individual sections 21 of the moving element 2 are divided by the partition walls 23. In addition, the partition walls 23 have small projections 232 in the radially outermost area, which are complementary to indentations 321 of the receiving element 3 (see FIG. 3A). During a relative movement in the form of a rotation of the moving element 2, these projections 232 engage with the notches 321 of the receiving element 3, so that an increased resistance for a renewed relative movement is created. FIG. 2C also shows that all sections 21 have the same angular regions 211, so that exactly one capsule can be accommodated per section 22. FIG. 2C shows that the area 22 becomes wider radially outwards with increasing distance from the center of gravity 121 of the moving element 2 in the vertical direction.

FIGS. 3A and 3B show an oblique side view from above and an oblique side view from below of the receiving element 3. The receiving element 3 has a round base surface 35 and encloses the receiving area 31 for the capsules with the side wall 6 in a cylindrical shape. The base surface 35 is inclined radially outwards from a center of the receiving element 3 vertically downwards (see FIG. 4B). A connecting element 38 is arranged on an upper side of the receiving element 3, which enables a rotatable connection with a moving element 2 (see FIG. 1). The connecting element 38 forms a cylindrical elevation in the center of the receiving area 31 with a protruding region 371. As can be seen in FIG. 3B, the cylindrical elevation is hollow in order to save material. The protruding portion 371 is arranged in an angular region of a dispensing area 4, so that the user can easily align the dispensing area 4 with a passage 41. On an upper edge of the side wall 6, indentations 321 are also arranged at a distance from adjacent sections from each other. The indentations 321 can form a slight resistance with the protrusions 232 of the moving element 2 (see FIGS. 2A and 2B) for a relative movement of the moving element 2 after each distance of a section. Thus, a user can notice by haptic feedback that it has been rotated by the angular regions 211 (see FIG. 2C) and that a capsule has been executed, for example. FIG. 3B shows that a connecting element 37 in the form of a cylindrical recess with a locking mechanism by means of latching elements is arranged centrally on an underside of the receiving element 3. The connecting element 37 can detachably connect the underside of the receiving element 3 to a complementary connecting element on the upper side of a moving element 2. In addition, the receiving element 3 has three recesses 322 in the radially outer region of the base surface 35. The recesses 322 are used for rotation-proof connection to the connecting element of a coffee machine (see FIG. 7). The connection area can have complementary connection elements for this purpose.

FIGS. 4A and 4B show an oblique side view of a system 401 consisting of two capsule dispensers 1011, 1012 arranged one above the other and a cross-sectional view of the system 401. Also shown is a system 301 consisting of a single capsule dispenser 1012 and an exemplary capsule 8 in a dashed representation to show that it is arranged inside the capsule dispenser 1012. The receiving elements 3 and moving elements 2 of the capsule dispensers 1011, 1012 in FIG. 4A are made of polymethyl methacrylate so that they are substantially transparent and thus easily visible to a user. In another embodiment of the system 301 with a capsule dispenser 1012, which has already been filled with capsules 8 at the factory, less expensive materials such as cardboard or a thin-walled plastic can be used. Accordingly, the system 301 can be manufactured particularly cheaply. The upper capsule dispenser 1011 forms a cylindrical system 401 with the lower capsule dispenser 1012. The side walls 61, 62 of the cylindrical system 401 form a continuous cylindrical outer surface. The capsule dispensers 1011, 1012 are identical in construction and can thus be easily detachably connected and combined with one another as a modular system. The capsule 8 is arranged in a receiving area 31 (see FIG. 1 and FIG. 3) in the prism-shaped areas 22 of the section and enclosed by the partition walls 23 and the side walls 61, 62. The prism-shaped area 22 has been marked with a dashed line to indicate that it is located inside the capsule dispenser 1012 under the side wall 62. In this embodiment, the receiving area can hold nine capsules 8 at a time in a horizontal plane. A capsule 8 in a dispensing area 4 of the capsule dispenser 101 would not be retained and would be carried out of the dispensing area 4. Therefore, such a capsule dispenser 101 allows each capsule 8 to be in a separated area 22 and the capsule dispenser 101 can be lifted and/or moved without allowing a capsule 8 to fall out. FIG. 4B shows that the receiving area of the receiving element 3 is inclined radially outwardly from an axis of rotation 12 in a vertical downward direction, so that the capsules 8 are arranged in a radially outer area of the capsule dispenser 1012 by gravity alone. The vertical axis of rotation 12 extends through a center of gravity 121 of the individual elements 2, 3, 1011, 1012. An angle of inclination 311 of the receiving area is 15° relative to a horizontal 11 in an operating position 10 of the capsule dispenser 1011, 1012. However, the capsules 8 are prevented from being carried out of the capsule dispenser 1012 by the side wall 61, 62, except in the dispensing area 4 with a passage 411, 412. The receiving element 3 of the lower capsule dispenser 1012 can be connected to a connection area 9 (see FIG. 5) of a coffee machine by three recesses 322 in a rotation-proof and non-slip manner. A moving element 2 is rotatably connected by a hollow cylindrical connecting element 27 on its underside to the cylindrical connecting element 38 on the upper side of the receiving element 3. A ribbed handle 28 of the lower capsule dispenser 1012 is rotation-proof connected to a connecting element 37 on the underside of the receiving element 3 of the upper capsule dispenser 1011 (see FIGS. 2A and 3B). The ribbed handle 28 is surrounded by a vertically lowered area 29 of the moving element 2. The receiving element 3 of the upper capsule dispenser 1011 is in turn rotatably connected to the moving element 2 of the upper capsule dispenser 1011.

As a first operating element 131, the ribbed handle 28 of the upper capsule dispenser 1011 can be rotated by a user to rotate the upper moving element 2 relative to the rest of the system 401 about the vertical axis of rotation 12. In addition, the ribbed handle 28 can be used to remove the upper moving element 2, which serves as a kind of lid 7 to protect it from dust. Thus, the receiving area of the upper capsule dispenser 1011 can be easily filled with new capsules 8. By a relative rotation of the upper moving element 2, the capsules 8 within the upper capsule dispenser 1011 can thus all be moved simultaneously relative to a dispensing area 4 and fed to the dispensing area 4. Due to their round rotationally symmetrical shape, the capsules 8 roll very smoothly through the relative rotation of the moving element 2.

The sidewall member 61 of the upper capsule dispenser 1011 may further serve as a second operating element 132. The side wall element 61 can perform a relative rotation to the receiving element 3 of the lower capsule dispenser 1012 by actuation by a user. The side wall element 61 is a materially connected component of the upper receiving element 3. The side wall element 61 is also rotation-proof connected to the moving element 2 of the lower capsule dispenser 1012 by the connecting elements 28, 27. A rotation of the side wall element 61 thus leads to a rotation of the parts of the system 401 relative to the receiving element 3 of the lower capsule dispenser 1012. An actuation of the second operating element 132 of the side wall 61 can thus cause a relative rotation of the moving element 2 of the lower capsule dispenser 1012. This relative rotation, which also rotates about the axis of rotation 12, can cause a capsule 8 to be fed from the receiving area of the lower capsule dispenser 1011 to the dispensing area 4. Due to the inclination of the dispensing area 4, the capsule 8 is carried out of the passage 412 of the lower capsule dispenser 1012 by gravity alone once the capsule 8 has been rolled into the dispensing area 4. The upper side wall element 61 can also be lifted together with the lower moving element 2 and the upper capsule dispenser 1011, so that new capsules 8 can be fed to the receiving area 31 of the lower capsule dispenser 1012. Of course, the upper capsule dispenser 1011 and the lower moving element 2 can also be lifted individually. The moving elements 2 of the upper capsule dispenser 1011 and lower capsule dispenser 1012 can be rotated about the axis of rotation 12 in both directions of rotation. Thus, for example, different capsule types can be arranged on the respective sides and the capsule 8 of one capsule type can be carried out of the capsule dispensers 1011, 1012 in one direction of rotation and the capsule 8 of another capsule type can be carried out in the other direction of rotation.

FIG. 5 shows an oblique side view of a coffee machine 201. A connection area 9 is arranged on the coffee machine 201 for receiving a capsule dispenser or system described above comprising at least one capsule dispenser. The connection area 9 has three connection elements 91 in the form of protruding pins, so that a rotation-proof attachment of a capsule dispenser can be ensured. The coffee machine 201 has an input area 5 which is surrounded by a funnel 51. The hopper 51 can feed capsules, in particular essentially round capsules, from a capsule dispenser or manually fed capsules to a brewing unit inside the coffee machine 201. The coffee machine 201 further comprises a plurality of buttons 133 that can be used to operate the coffee machine 201 and/or a capsule dispenser. In particular, the buttons 133 may be provided to control the relative movement of the capsule dispenser.

FIG. 6 shows an oblique side view of a system 401 consisting of two capsule dispensers 1011, 1012 arranged one above the other on the coffee machine 201. The lower capsule dispenser 1012 is loaded with capsules 8 as system 301. For structural features and functions already described, reference is made to the description of FIG. 4A, FIG. 4B, and FIG. 5. A passageway 412 of the lower capsule dispenser 1012 and a passageway 411 of the upper capsule dispenser 1011 are arranged substantially vertically one above the other in the operating position 10 of the system 401. Capsules 8 that are located in the lower dispensing area 42 of the lower capsule dispenser 1012 roll into the hopper 51 of the input area 5 of the coffee machine 201 due to the inclination of the dispensing area. Capsules 8 that are carried out of the upper dispensing area 43 of the upper capsule dispenser 1011 fall into the hopper 51 and are also fed to the input area 5 of the coffee machine 201. In the operating position of the capsule dispensers 1011, 1012, the input area 5 of the coffee machine is arranged vertically below the passages 412, 411 of the side wall elements 61, 62, so that the capsules 8 can be fed by gravity alone. A distance and an inclination of the dispensing area 43 and the position of the input area 5 are coordinated so that the capsules 8 can be reliably fed to the input area 5 by a relative rotation of the moving element 2 to the receiving element 3 (see FIGS. 3A and 3B). The receiving element 3 of the lower capsule dispenser 1012 is connected rotation-proof by the connection elements 91 of the connection area 9 (see FIG. 5) and the recesses 322 of the receiving element 3 (see FIG. 3A and FIG. 3B).

This arrangement results in free access to the input area 5 without obstruction by the capsule dispensers 1011, 1012. Thus, the user can, for example, manually feed capsules 8 of other capsule types directly. In addition, the user can continue to operate the coffee machine 201 despite the capsule dispensers 1011, 1012 being empty, without the capsule dispensers 1011, 1012 necessarily having to be refilled or replaced. The relative movements of the capsule dispensers 1011, 1012 can be controlled automatically by operating elements in the form of buttons 133 of the coffee machine 201 by means of an internal motor with a transmission. Alternatively, the lid 7 can serve as an operating element 131 for manual operation by a user (see FIG. 4A and FIG. 4B).

FIG. 7 shows a cross-section of the system 401 comprising two capsule dispensers 1011, 1012 each with a capsule 8 in the dispensing area 42, 43 in an operating position 10 on a coffee machine 201. For structural features and functions already described, reference is made to the description of FIG. 4A, FIG. 4B, FIG. 5, and FIG. 6. The capsules 8 were rolled into the dispensing areas 42, 43 in the circumferential direction of the capsule dispensers 1011, 1012 by a relative rotation of the upper moving element 2 and lower moving element 2. A receiving element 3 of the lower capsule dispenser 1012 is connected to the connection area 9 in a rotation-proof manner. However, the receiving element 3 of the upper capsule dispenser 1011 can be rotated by rotating the side walls 61, 62 through rotation-proof connecting elements 27, 38 (see FIG. 4A and FIG. 4B). The relative movement can be actuated by the ribbed handle 28 as a first operating element 131, the upper side wall 61 as a second operating element 132, or by buttons 133. By inclining the receiving area 31 of the capsule dispenser 1011, 1012 radially outwards, the capsules 8 can roll through the passages 411, 412 in the side walls 61, 62 and be fed to the input area 5 via the hopper 51.

FIGS. 8A and 8B show a perspective view of a first alternative embodiment of the moving element 2 and a second alternative embodiment of the moving element 2. The moving element 2 in FIGS. 8A and 8B forms a lid 7 for the receiving element 3 (see FIGS. 9A to 9C). An underside 24 of the moving element 2 essentially forms a flat surface, which has a cylindrical upwardly directed bulge 13 in the center in the area of its center of gravity 121. In addition, the underside 24 in FIG. 8A has a contact element 14 in the form of a curved partition wall. The underside in FIG. 8B, on the other hand, has two oppositely arranged contact elements in the form of two curved partition walls 141, 142. The curvature of the partition walls 14, 141, 142 is shaped to increase the contact surface to the capsules so that they can be guided more reliably. The partition walls 14, 141, 142 in FIGS. 8A and 8B serve to move the capsules 8 (see FIG. 1A) to a dispensing area by rotating the moving element 2 when it is fixed in the receiving element. By means of two separate partition walls 141, 142 according to FIG. 8B, capsules can be transported from two different areas (see FIG. 10A and FIGS. 12A, 151 and 152) to the dispensing area by contact with the partition walls 141, 142, depending on the direction of rotation of the moving element 2.

The bulge 13 in FIGS. 8A and 8B forms an operating element 13 (see FIG. 10B) on a side 25 facing away from the viewer, which is materially connected to a protruding arm 251 extending radially from the operating element to an edge 241 of the moving element 2. The edge 241 also has an elevation 242 in the circumferential direction of the moving element 2, which can engage in the side walls of the receiving element in order to fix the moving element 2 rotatably relative to the receiving element. The elevation 242 thus forms a connecting area 27 to the receiving element. The upper edge of the receiving element in FIGS. 9A and 12A is complementarily shaped to receive this connecting area 27.

FIGS. 9A to 9C show a perspective view from above and from below as well as a top view of a first alternative embodiment of the receiving element 3. The receiving element 3 has an edge 38 on an upper side 34, in an upper region of a cylindrical side wall 6, which serves as a connecting element to a moving element. A base surface 35 of the receiving element 3 extends orthogonally to the side wall 6 and has a passage 41 in the center, through which the capsules can be carried out by a relative movement of the moving element to the receiving element 3. The base surface 35 also has a guide track 351, which extends partially in the circumferential direction and leads to the passage 41. In an initial region and an end region, the guide track 351 has a respective elevation 352, 353 in order to retain the capsules. A width 355 of the guide track 351 is smaller than the dimension of the capsule, so that the capsules are held in the guide track 351 without being able to move transversely to the guide track 351. The height of the guide track 351 is significantly less than the dimensions of the capsules, so that they can be guided along the guide track 351 in a material-saving manner. In addition, the receiving element 3 has a guide area 354. The guide area 354 serves to reliably guide the capsules through partition walls 14, 141, 142 (see FIGS. 8A and 8B) via the retaining elevation 352 to the passage 41 during the relative movement of the moving element to the receiving element. The capsules thereby roll along the guide track 351 by pushing the capsules through the partition walls of the moving element (see FIG. 8A and FIG. 8B).

An underside 33 of the receiving element 3 is formed flat and has the passage 41 in the center for feeding out the capsules. In addition, the passage 41 is surrounded by a cylindrically protruding area, which is shaped as a connecting element 37 with a coffee machine.

FIGS. 10A and 10B show a perspective view of a second alternative embodiment of the receiving element 3 and a side view of a capsule dispenser 101 comprising a receiving element 3 according to FIG. 10A and a moving element 2 according to FIG. 8B.

The receiving element 3 in FIG. 10A has two curved guide tracks 3511, 3512 in the form of a recess 356 on a base surface 35. In this embodiment, the guide tracks 3511, 3512 have a bottom, so that a base surface 35 of the receiving element is closed except for a passage 41 in the center.

In a further embodiment, the recesses 356 of the guide tracks 3511, 3512 may form a continuous opening from the top side to the bottom side in addition to the passage 41 for carrying out the capsules in a center of the receiving element 3. However, a width 357 of the recess 356 in such an embodiment is less than the dimensions of the capsules, so that the capsules can be held only on the guide track 351.

In an initial region and an end region, the two guideways 3511, 3512 each have a transition region 352, 353 to the base surface 35 in order to retain the capsules. In addition, the receiving element 3 in FIG. 10A has a raised separation area 354 so that capsules of the adjacent guideways 3511, 3512 cannot be exchanged between the guideways 3511, 3512 or fed to the passage 41 in a movement transverse to the guideways 3511, 3512. In a direction radially outwards of the receiving element 3, on the other hand, the capsules are retained by a side wall 6 of the receiving element 3. Such an arrangement makes it possible, for example, to transport the capsule dispenser 101 without the capsules of the guide tracks 3511, 3512 being exchanged or carried out. The contact elements 14, 141, 142 (see FIGS. 8A and 8B) of the moving element 2 are arranged in the area between the guide tracks 3511, 3512 at the separation area 354 according to FIG. 10A. By manually actuating the operating element 13 by rotating the protruding arm 251 of the moving element 2, the relative movement of the moving element to the receiving element 3 can be executed.

By a relative movement counterclockwise in a circumferential direction 15, capsules can be rolled out of the first guide track 3511 to the passage 41 and carried out by a contact with the first contact element 141 (see FIG. 8B). By a relative movement clockwise in a circumferential direction 15 of the receiving element 2, capsules can be rolled out of the second guide track 3512 to the passage 41 and carried out by contact with the second contact element 142 (see FIG. 8B). Such a receiving element 3 allows, for example, two different types of capsules to be used simultaneously by a user with a capsule dispenser.

FIG. 11 shows a perspective view of a system 301 comprising two capsule dispensers 1011, 1012 arranged next to each other on a coffee machine 201. The capsule dispensers 1011, 1012 are each fixed on a connection area 92, 93 of the coffee machine 201 and each have a moving element 2 according to FIG. 8B and a receiving element 3 according to FIG. 10A. The moving elements 2 each have an operating element 131, 132, so that the capsules can be inserted from passages of the capsule dispenser into an input area of the coffee machine 201 (not shown in FIG. 11). A button 133 of the coffee machine 201 can then be actuated in order to prepare a hot beverage. In an additional connection area 94, at least one further capsule dispenser 1011, 1012 can be stored or optionally several capsule dispensers 1011, 1012 can be stored stacked on top of each other.

The system in FIG. 12A to FIG. 12C shows another embodiment of a capsule dispenser.

FIG. 12A shows a perspective view of a receiving element 3 according to FIG. 10A. The same reference signs designate the same elements as in FIG. 10A. The receiving element 3 has additional spacers, e. g. three support legs 358, so that a passage 41 is raised. The support legs 358 may be suitable for placing the receiving element 3 on a surface or on a connection area 92, 93 of a coffee machine (see FIG. 11). Such support legs 358 of the receiving element 2 have the advantage that moisture from an input area of a coffee machine cannot directly enter the capsule dispenser.

FIGS. 12B to 12C show a side view of the receiving element 2 according to FIG. 12A with support legs 358, a side view in cross-section of a capsule dispenser 101 comprising a receiving element 3 according to FIG. 12A and a moving element 2 according to FIG. 8B.

The moving element 2 is attached to the receiving element 3 by an elevation 242 at an edge 241 of the moving element 2, so that it is rotatable in the circumferential direction. In a receiving area 31 of the receiving element 3, the capsules can be stored enclosed by a side wall 6 of the receiving element 3 in a guide track 3511 and 3512 (see FIG. 12A). By actuating an operating element 13 in the form of a cylindrical projection with an arm 251 of the moving element, a rotation of the moving element 2 with respect to the receiving element 3 can be generated. The capsules can thus be rolled along guide tracks 3511 and 3512 with recesses 356 to the passage 41 by contact with the contact elements 141, 142 as a result of the rotation. Thus, the capsules can be carried out of the capsule dispenser 101 past a separating area 354 of the receiving element 3.

FIGS. 13A-13C show a perspective view of a lid 7, a moving element 2 and a receiving element 3 of an embodiment of the capsule dispenser 101.

The lid 7 in FIG. 13A has a ribbed handle 28 on the upper side, which is formed by an annular region. A lowered annular toothed connecting portion is provided on an underside of the lid 7, so that the lid 7 is connectable to a toothed connecting portion on a toothed annular portion of the moving element 2. Due to the toothed connection, the lid 7 and the moving element 2 can be rotated together in a circumferential direction when they are connected to each other. This connection of the lid 7 and the moving element 2 allows the lid 7 to be easily removed from the moving element 2 so that capsules can be easily refilled.

The moving element 2 in FIG. 13B also has a plurality of capsule holders 211 shaped to receive capsules. Each capsule holder 211 can hold a capsule, so that the capsule merely touches the capsule holder 211.

The lid 7 and the moving element 2 can be inserted together into the receiving element 3 of FIG. 13C, so that the lid 7 and the moving element 2 can be rotated together relative to the receiving element 2. Thus, the capsules in the capsule holders 211 can be fed to a dispensing area 4 of the receiving element 3. The dispensing area 4 also has a discharge device, which is formed by a projection 311 in a dispensing area 4 of the receiving element 3. The projection 311 protrudes vertically from a base surface 35 of the receiving element 3 and has a convex shape.

The moving element 2 has an outer holding area 212 so that the capsules can be held in the capsule holder 211. When the moving element 2 is inserted in the receiving element 3, the capsules do not touch the receiving element 3. This allows the capsules to be moved together with the moving element 2 in a rest position during a rotational movement of the moving element 2 without rotating.

Only the projection 311 of the receiving element 3 in the dispensing area 4 is configured to lift the capsules against gravity when the capsule holder 211 is moved into the dispensing area 4 by the relative movement. By lifting the capsule from the rest position, the capsule can be carried out of the dispensing area 4 through a passage 412 in a side wall of the receiving element 3 with a rotational movement about its own axis (see FIG. 14B).

FIGS. 14A and 14B show a cross-sectional view of a capsule dispenser 101 according to FIGS. 13A-13C with a spherical capsule, which is held by the moving element 2 and is carried out of a dispensing area 4 by the projection 311 of the receiving element 3. FIGS. 14A and 14B show the capsule dispenser 101 in an operating position in which the lid 7 is connected to the moving element 2 in a rotationally secure manner and the lid 7 and the moving element 2 can be rotated together relative to the receiving element 3.

FIG. 14A shows that the capsule 8 is located in the capsule holder 211, so that the capsule 8 only touches the moving element 2. Thus, the capsule 8 in the capsule holder 211 can be moved in a rest position together with the moving element 2 by the relative movement without experiencing additional friction by the receiving element 3.

The moving element 2 in FIGS. 14A and 14B contacts the receiving element 3 only through a conical connection in the center and with the outer holding area 212. The capsule holders 211 are arranged elevated relative to the base surface of the receiving element 3.

The protrusion 311 and the moving element 3 are configured so that the protrusion 311 is arranged under the capsule holder 211 during the relative movement of the moving element 3 in the circumferential direction and does not touch the moving element 3 during the relative movement. The capsules 8 can be lifted out of the capsule holders 211 against gravity by the protrusion 311 during the relative movement, when a capsule holder 211 is moved to the dispensing area 4 by the relative movement.

The convex shape of the projection 311 enables the capsule 8 to be lifted continuously by the relative movement, without a jerky resistance against the relative movement.

1. A capsule dispenser for receiving and dispensing substantially rotationally symmetrical capsules in an operating position, comprising a receiving element and a moving element, wherein the receiving element defines a receiving area for the capsules, wherein the capsule dispenser has a dispensing area for dispensing a capsule, wherein
a capsule can be moved into the dispensing area by a relative movement between the receiving element and the moving element and wherein the capsule can be discharged from the dispensing area, wherein at least the movement of the capsule into the dispensing area or the movement for discharging the capsule from the dispensing area comprises a rotation of the capsule about one of its axes of symmetry.

2. The capsule dispenser according to claim 1, wherein the receiving area is inclined to the horizontal at least in a partial area or completely in the operating position of the capsule dispenser and/or has a discharge device which is configured to discharge the capsule by the relative movement between the receiving element and the moving element at the dispensing area.

3. The capsule dispenser according to claim 1, wherein the moving element and the receiving element are connected or connectable to one another.

4. The capsule dispenser according to claim 1, wherein the relative movement is a rotational movement, so that one individual capsule can be carried out of the dispensing area after the other.

5. The capsule dispenser according to claim 1, wherein the capsule dispenser comprises sections of angular regions, wherein each section is delimited by two separating elements forming an area for receiving exactly one capsule.

6. The capsule dispenser according to claim 1, wherein the capsule dispenser comprises a side wall element which is oriented substantially vertically in the operating position and is connected or connectable to the receiving element.

7. The capsule dispenser according to claim 1, wherein the capsule dispenser comprises a lid which is connected or connectable to the moving element or the receiving element so that a relative movement of the lid causes the relative movement.

8. The capsule dispenser according to claim 1, wherein the capsule dispenser comprises an operating element for causing the relative movement.

9. The capsule dispenser according to claim 1, wherein at least a part of the capsule dispenser is transparent or semi-transparent.

10. The capsule dispenser according to claim 1, wherein the receiving element comprises at least one connecting element for rotation-proof connection to one of a moving element of another, second capsule dispenser and/or to a connection area of a beverage preparation machine.

11. A system comprising a capsule dispenser according to claim 1 and a plurality of capsules, wherein the capsules are arranged in the receiving area of the capsule dispenser and are substantially rotationally symmetrical about at least one axis.

12. A system comprising at least two capsule dispensers according to claim 1, wherein the system in the operating position comprises at least two capsule dispensers arranged vertically one above the other, which are detachably connected to each other.

13. A beverage preparation machine, comprising at least one capsule dispenser according to claim 1, wherein the beverage preparation machine has a connection area for connecting the capsule dispenser.

14. The beverage preparation machine according to claim 13, wherein the beverage preparation machine comprises an input area for inputting a capsule for beverage preparation, wherein the dispensing area of the capsule dispenser corresponds to the input area of the beverage preparation machine.

15. The beverage preparation machine according to claim 13, wherein the beverage preparation machine or the capsule dispenser comprises a guide device and the guide device is arranged or can be arranged between the dispensing area and the input area.

16. The capsule dispenser according to claim 2, wherein the discharge device is configured to discharge the capsule by the relative movement by the capsule being lifted at least partially against gravity by the discharge device and the relative movement.

17. The capsule dispenser according to claim 3, wherein the relative movement enables all capsules to be moved relative to the dispensing area without the capsules performing a rotation about one of their axes of symmetry except in the dispensing area, in that the moving element has at least one capsule holder for receiving at least the capsule, so that the capsule merely touches the capsule holder.

18. The system according to claim 11, wherein the plurality of capsules are substantially rotationally symmetrical about at least two different axes.

19. The beverage preparation machine according to claim 13, wherein the connection area comprises one of a recess and a magnetic connecting element and is configured for receiving at least a part of the receiving element of the capsule dispenser.

20. The beverage preparation machine according to claim 15, wherein the guide device is at least partially inclined to a horizontal in an operating position of the beverage preparation machine, so that a capsule discharged from the dispensing area can be fed to the input area only by its own weight.
